(19) United States
(12) Patent Application Publication
(10) Pub. No.: US 2013/0168317 A1
(43) Pub. Date: Jul. 4, 2013

(54) METHOD AND APPARATUS FOR REMOVAL OF TARS, RESINS, CHARS OR VOLATILES FROM A LIQUID

(71) Applicant: Cedric Jean-Luc Vanderbeken, Vancouver (CA)

(72) Inventor: Cedric Jean-Luc Vanderbeken, Vancouver (CA)

(73) Assignee: Vanderbeken Enterprises Ltd. DBA DRYCAKE, Sudbury (CA)

(21) Appl. No.: 13/710,014

(22) Filed: Dec. 10, 2012

Related U.S. Application Data
(63) Continuation-in-part of application No. 13/341,602, filed on Dec. 30, 2011.

(51) Int. Cl. C02F 1/38

(52) U.S. Cl. CPC C02F 1/385
USPC 210/663; 494/37; 494/51

(57) ABSTRACT

The invention is a method and apparatus for processing tarry or resinous liquid suspensions derived from gasification, pyrolysis or drying of biomass. The suspensions are processed by a horizontal axis centrifuge having a discharge chamber containing a scraper to prevent centrifuge clogging or fouling, a volatiles exhaust system utilizing suction, and a means to isolate the gas and light solids radially of the inner liquid surface and thereby enabling the gas and light solids to be extracted continuously to a location outside the centrifuge bowl. The removed tar, char and volatiles can be used as fuel or recycled as feedstock. Polymers can be added prior to centrifugation to assist in solids/liquids separation. Tar, resin, char or volatiles depleted wet scrubber liquid can be recycled for further use or easily treated prior to disposal.

### RELATED U.S. APPLICATION DATA

Continuation-in-part of application Ser. No. 13/341,602 filed on Dec. 30, 2011,

US Cl.: 210/151, 210/600, 208/39, 209/166, 494/37, 494/900

### RELATED PATENTS

### U.S. Patent Documents

### Field of Classification Search 208/39, 209/166, 210/623, 210/151, 423/230, 494/37, 494 /53, 494/56, 494/900, 585/802,

### References Cited

### US Patent Documents

US20120216460 A1 2012-08-03 Robin Zwart C10J 3/84

U.S. Pat. No. 7,626,069 2008 Feb. 2012 Thomas Nissen 585/802

U.S. Pat. No. 4,443,213 1984 Apr. 17 Goffrey L. Brimwood 494/39, 494/53, 494/900

### Other Publications

T. A. Milne, et al., “Biomass Gasification Tars, Their Nature, Formation, and Conversion”, NRELITP 570-25357, November 1998

Devi et al., “A Review of the Primary Measures for Tar Elimination in Biomass Gasification Systems”, Biomass and Bioenergy, 2003. 24(2):125-140

Ziad Abu El-Rub ,“Biomass char as an in-situ catalyst for tar removal in gasification systems”, 2008, (p73-95)

### FIELD OF THE INVENTION

The present invention relates to a method and a device for separating tars, char and volatiles from synthesis gas (syngas) wet scrubber or wet electrostatic precipitator (WESP) aqueous liquid suspensions such as those derived from gasification or pyrolysis of biomass and other carbonaceous feed stocks. The present invention also relates to a method and device for separating resins from wet scrubber or WESP aqueous liquids such as those derived from resin containing biomass driers.

### BACKGROUND AND DESCRIPTION OF THE PRIOR ART

It is known that waste to energy plants, for example biomass waste to energy plants, have used a wet scrubber or WESP apparatus for cleaning the syngas of tar and/or char so that the syngas is more suitable for use as a fuel. Tar is typically defined as all organic compounds including phenols present in the syngas excluding volatile hydrocarbons (containing 1 to 6 carbon atoms per molecule) and benzene. Since a water containing scrubber or WESP solution is hydrophilic and the tar and/or char or resin are hydrophobic and semi-hydrophobic i.e. semi-hydrophilic, the scrubber or WESP liquid converts to a tarry suspension in water. Volatiles including gases and organics are also contained in the scrubber or WESP liquids.

Synthesis gas (syngas) tars and chars are formed in both pyrolysis and gasification of biomass (e.g. wood waste, municipal solid waste) and non-biomass containing feedstock (e.g. rubber and tires). It is possible to easily remove a significant proportion of the tars by tar condensation in a water containing scrubber or wet electrostatic precipitator (WESP) but this results in contamination of the water, the water soluble or water miscible components of tars (e.g. phenols) causing problems, since they are difficult to remove from the water and interfere with bio-treatment of the contaminated water at high concentrations. Tars are a significant impediment to the utilization of syngas in turbines or motors due to their tendency to condense and foul the motors, turbine blades or vanes, or chemical synthesis equipment leading to blockage or damage of the motors, turbines or chemical synthesis apparatus.

Chars can cause damage of motors or turbines due to abrasion or fouling. Volatiles contained in the contaminated water may be odorous, flammable or toxic causing a potential safety or health hazard.

The resinous or tarry suspension of resin or tar and/or tar containing hydrophilic liquid such as water is extremely difficult to handle by prior art techniques including concentration, filtration, adsorption, thickening, use of cyclones or dehydration. The untreated product remains extremely hazardous if spilled into the environment since it contains numerous toxic components e.g. phenols, mono-aromatic and poly-aromatic hydrocarbons. The prior art has tried to avoid the processing of aqueous tar, char and volatiles containing aqueous liquid suspensions derived from gasification of biomass by avoiding the use water altogether e.g. US 20120216460 or processing liquid suspensions by expensive, exotic separations and upgrading e.g. U.S. Pat. No. 7,626,069.

According to a study published by the National Renewable Energy Laboratory, currently available technologies for tar removal do not meet the needs of the industry in terms of cost, performance, and environmental considerations (T. A. Milne, et al., “Biomass Gasification Tars, Their Nature, Formation, and Conversion”, NRELITP 570-25357, November 1998). Devi et al. further illustrate problems associated with handling tars derived from biomass processing (“A Review of the Primary Measures for Tar Elimination in Biomass Gasification Systems”, Biomass and Bioenergy, 2003. 24(2):125-140).

Accordingly, a need exists for a method and a device for treating this waste stream in an effective and simple way.

### SUMMARY OF THE INVENTION

The current invention is a method and apparatus for cleaning resin, tar, char or volatiles bearing aqueous scrubber or WESP liquids derived from gasification, pyrolysis or drying of biomass containing feed stocks.

A decanter centrifuge, equipped with a moving scraper external to the centrifuge bowl, separates the majority of the tars and chars from the liquids while facilitating the adsorption of tar by the chars and non-fouling of the centrifuge by tarry or resinous solids.

Tar as an adsorbant is illustrated in: Ziad Abu El-Rub ,“Biomass char as an in-situ catalyst for tar removal in gasification systems”, 2008,(p73-95)

Volatiles and trace amounts of un-adsorbed tar components including light solids in the remaining liquid are further separated in the centrifuge via suction and evaporation. Both the separated tarry solids containing char and the evaporated volatile and tar components can be recycled for further use e.g. gasification or combustion. Supplementary adsorbents such as char or activated carbon can be added to the liquids prior to centrifugation to further enhance removal of resins, tars, char or volatiles from the liquids.

This method allows separation of liquid suspension into 3 different phases: solids (char and adsorbed tar components), clarified liquid phase and gas-light solids phase.

### BRIEF DESCRIPTION OF THE DRAWINGS

FIG. 1 shows the cross section of a horizontal axis centrifuge as known through previous art

FIG. 2 shows the cross section of a horizontal axis centrifuge and the changes by this invention

### DETAILED DESCRIPTION OF THE DRAWINGS

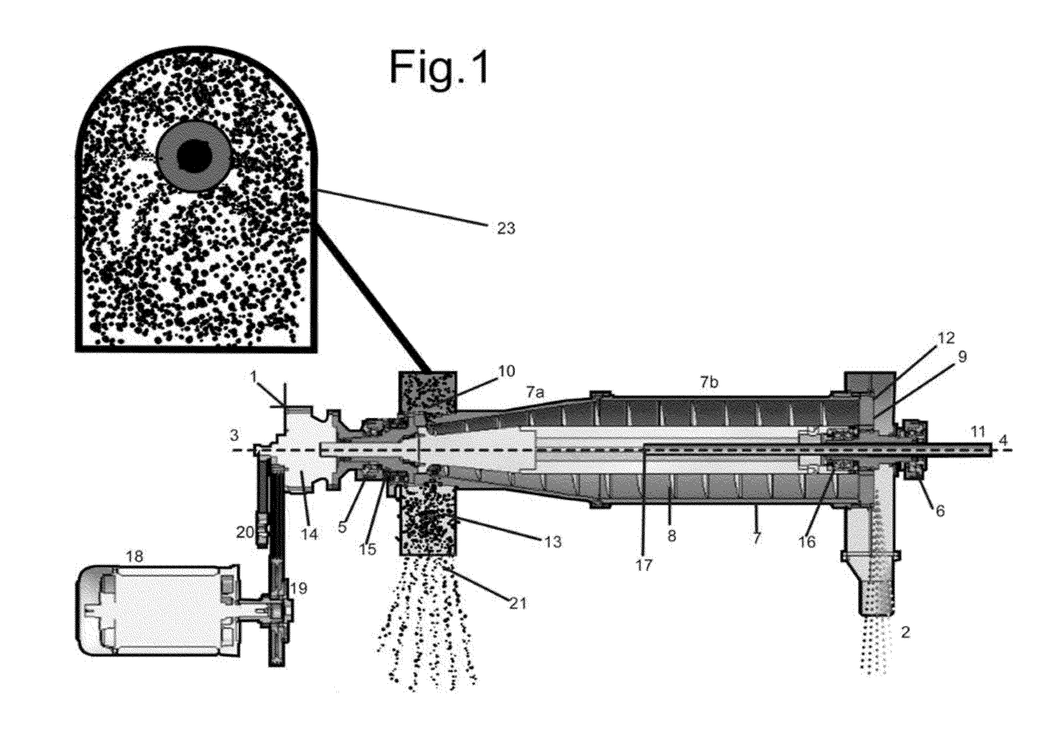

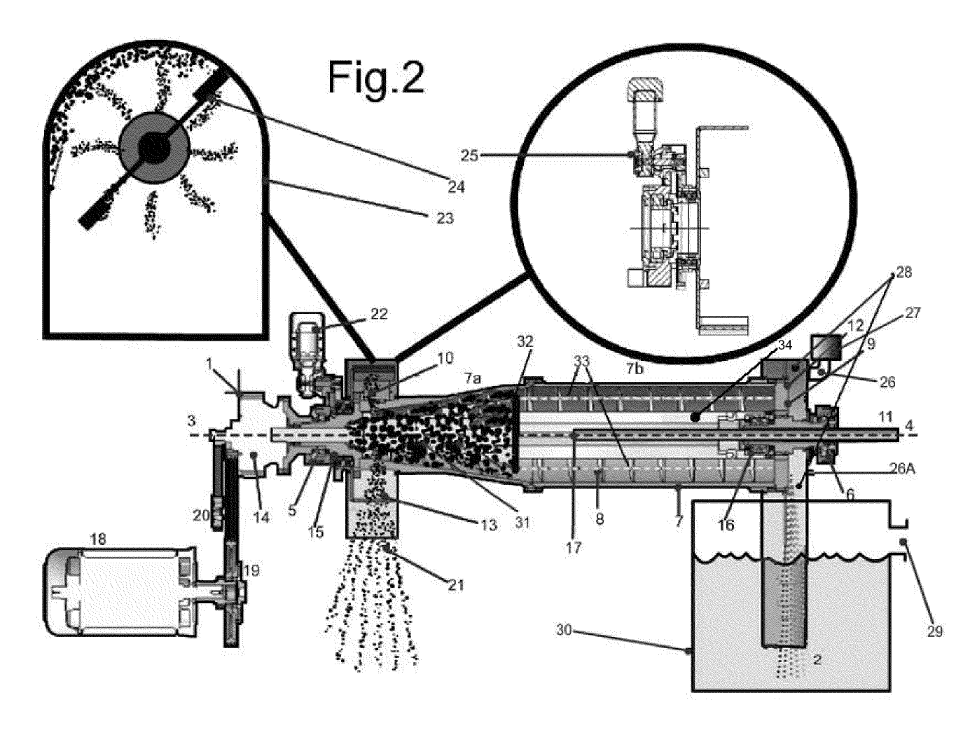

FIGS. 1 and 2 illustrate the method and apparatus of the current invention:

FIG. 1 illustrates a horizontal axis centrifuge 1 which can be used for separating feed tarry or resinous suspension 4 via inlet 11 into cleaned liquid 2 and tarry solids 13. The centrifuge 1 includes a horizontal rotation axis 3 and two bearings 5 and 6 on which a bowl 7 is rotating. Within bowl 7 there is a rotatable screw 8 supported rotationally with respect to the axis 3 by two bearings 15 and 16. The horizontal axis centrifuge 1 provides a centrifugal G-force of 1000 to 3200 on resinous or tarry suspension which activates the char (e.g. bio-char) naturally present or added in the tarry or resinous liquid as an adsorptive measure to separate out the tarry suspension out of the liquid phase and into tarry solids 4 introduced via inlet 11. Screw 8 turns inside bowl 7 with a different speed than the bowl. Bowl 7 is driven by a motor 18 via pulley 19. Screw 8 is driven by a pulley 20 and via gearbox 14 allowing for a different speed between bowl 7 and screw 8. A hydraulic or electric motor, with differential speed control, can be used as a substitute for pulley 20. Bowl 7 is provided with a liquid phase outlet 9 and a tarry or resinous solids phase outlet 10. Outlet 9 of cleaned liquid 2 may be provided with an adjustable weir disk or plate 12 at the rear wall of bowl 7, and the tarry or resinous solids outlet 10 is provided at the opposite wall of bowl 7 with a conical section 7a. Screw 8 serves as a transportation means for material along the cylindrical, non-conical 7b section of bowl 7, radially and inwardly along the conical bowl section 7a towards the outlet 10. Tarry or resinous suspension 4, with or without polymer (e.g. cationic polymer) added to agglomerate solids, introduced through inlet 11 at the centre of the centrifuge axis, is introduced the centrifuge bowl 7 at feed point 17. The cleaned liquid 2 is discharged via the outlet 9 across the adjustable weir disk 12, or straight out when no weir disk or weir plate is used. The tarry or resinous solids 13 are discharged via screw 8 along conical bowl section 7a through outlet 10 contained in discharge chamber 21. Tarry or resinous suspension 4 can be further supplemented with tarry or resinous solids and/or activated carbon to supplement adsorption of hydrophobic and semi-hydrophobic organic from the suspension 4 onto tarry or resinous solids 13 to further enhance the quality of cleaned liquid 2.

FIG. 2 illustrates a scraper and a volatiles extraction system used in combination with the components of the apparatus illustrated in FIG. 1. Scraper 24 of scraper assembly 25 serves to prevent deposition of tarry or resinous solids inside the solids discharge chamber assembly 21 and discharge chamber sub-assembly 23 via separate turning movement from bowl 7 or screw 8 via motor 22. FIGS. 1 and 2 illustrate the relative buildup of tarry or resinous solids inside the discharge chamber subassembly 23 with and without scraper 24 respectively. Lack of scraper 24 together with scraper assembly 25 results in uncontrollable, and undesirable repetitive fouling of discharge chamber assembly 21 and its subassembly 23. The apparatus separates the tarry or resinous liquid suspension into 3 phases: a solid, a liquid and a gas. The gas phase containing volatiles and possible entrained light solids (e.g. naphthalene) exits through the centre portion without solids or liquid 34 and out the exhaust 26 to one-side (right side in FIG. 2) a static annular plate 32 which does not touch the centrifuge bowl wall and has a diameter greater than the liquid level 33. The annular plate 32 allows for the formation of a tarry or resinous solids concentrate on the solids discharge side (left side in FIG. 2) and isolates the gas from the solids discharge side 13. The gas and light solids leave the center portion 34 through the center portion in the liquid discharge weirs 9 to go into the liquids discharge chamber 28. The liquid with a maximum level 33 depleted in solids comes out of the apparatus through weir plates 9 in the liquid discharge chamber to one side (right side in FIG. 2). Gas is isolated from the liquid phase in two ways—1) by submerging the liquid discharge 2 into a tank 30 with overflow 29 with a discharge depth 2 below the liquid level of tank 30 and 2) Gas and entrained light solids are extracted out of the horizontal axis centrifuge by means of an extraction system consisting of an optional inlet 26A and an exhaust 26 connection to a suction source, for example a variable or fixed speed suction fan 27 allowing for controllable degree of suction and gas extraction, or simply exiting through outlet 26 The outlet through 26 can be recycled as fuel, gasifier input or flared in whole or part. The quality of gas, liquid and solids separation, and the gas isolation from the solids discharge side can be controlled by adjusting the differential speed between the bowl 7 and screw 8.

The prior art e.g. U.S. Pat. No. 4,443,213 shows separation of gas from solids in a decanter centrifuge, however this centrifuge design would not allow light solids to be removed due to plugging of the central pipe by light solids, unlike the current invention which separates solids (char with adsorbed tars), gas-light solids and clarified liquid from a liquid suspension without fouling of the centrifuge.

The following 3 non-limiting examples describe the current invention:

### Example 1

### Processing of Tarry Wet Scrubber or WESP Liquid Suspension Derived from Municipal Solid Waste Biomass Gasification

Tarry suspension containing 0.5% solids by weight was input to the apparatus described in FIGS. 1 and 2 above with the following resulting output streams:
cleaned liquid having a solids content of 58 milligrams/litre and a phenols content of 14.8 milligrams/liter (input tarry suspension contained 1950 milligrams/litre of phenols i.e. >99% phenols reduction) suitable for recycling, treatment (e.g. biotreatment) or discharge
powdery solids containing 75% solids having a heating value of −25 megajoules/kilogram and suitable for use as fuel or for recycling into the gasifier

### Example 2

### Processing of Tarry Wet Scrubber or WESP Liquid Suspension Derived from Wood-chip Gasification

Tarry suspension containing 20% solids by weight was input to the apparatus described in FIGS. 1 and 2 above with the following resulting output streams:
cleaned liquid having a solids content of 510 milligrams/litre and a phenols content of 20.5 milligrams/litre (input tarry suspension contained 2250 milligrams/litre of phenols i.e. >99% phenols reduction) suitable for recycling, treatment (e.g. biotreatment) or discharge
tarry solids, containing 73% solids, having a heating value of −25 megajoules/kilogram and suitable for use as fuel or for recycling into the gasifier.

### Example 3

### Processing of Resinous Liquid Suspension Derived from Drying of Coniferous Biomass Solids

In the drying process of coniferous biomass, e.g. spruce or pine, hydrocarbons, including aromatics and resins, go into the vapour phase, and are partially condensed by reducing the temperature. However much resin, especially resin molecules that condense at lower temperatures remain in the vapour stream. This vapor can be scrubbed with water to remove its contained resin and the resulting resinous water scrubber or WESP liquid can be fed into the horizontal axis centrifuge described in this invention to separate the contained resin in whole or part from the scrubber or ESP liquid. The scrubber or ESP liquid can then be recycled in whole or part or further treated in whole or part.

The above examples illustrate the numerous advantages of the current invention:
the high centrifugal G-force and turbulence of the centrifuge dramatically enhance the adsorptive performance of the char and/or supplementary sorbent (e.g. activated carbon), due to massive improvement in mass transfer towards tars contained in the liquid suspension and the separation of char-tar from the liquid suspension.
Char-tar recycling is straightforward due to the excellent separation of char-tar from the liquid suspension. Tars typically represent 5 to 20% of the energy content of syngas. Recycling of the char-tars can dramatically enhance gasifier or combustor performance.
Simple modification of a horizontal axis decanter centrifuge with respect to scraper and volatiles exhaust accessories allows simultaneous removal of char-solids and volatiles from the liquid suspension which maximizes cleanliness of the resulting solids and volatiles depleted liquid facilitating further treatment e.g. biotreatment and/or disposal.

I claim:

1. A method of cleaning tarry or resinous liquid suspensions wherein the method of separating the tarry or resinous solids from the liquid contained in the suspension is via a centrifuge containing a separately moving bowl, feeder screw and a discharge chamber scraper located outside of the bowl that prevents fouling of the centrifuge discharge chamber by tarry or resinous solids as well as an outlet located in the liquids discharge chamber to allow volatiles removal from the char-solids depleted liquid suspension.

2. The method of claim 1 in which the volatiles include light solids.

3. The method of claim 2 in which the light solids contain naphthalene.

4. The method of claim 1 in which the centrifuge is a horizontal axis type.

5. The method of claim 1 in which the liquid suspension is a wet scrubber liquid containing tar and/or tar/char solids.

6. The method of claim 1 in which the liquid suspension is a wet electrostatic precipitator liquid containing tar and/or tar/char solids.

7. The method of claim 5 in which tar is adsorbed by the char.

8. The method of claim 1 in which supplementary solids are added to the liquid suspension.

9. The method of claim 8 in which supplementary solids contain activated carbon.

10. The method of claim 1 in which the liquid suspension is a resin containing liquid derived from coniferous biomass solids.

11. The method of claim 1 in which the liquid suspension contains water.

12. The method of claim 6 in which tar is adsorbed by the char.

13. The method of claim 1 in which the tarry or resinous liquid suspensions contain phenols.

14. The method of claim 8 in which phenols are extracted from the liquid suspension into the separated tarry or resinous solids via centrifugation.

15. The method of claim 8 in which phenols are contained in the separated tarry or resinous solids.

16. The method claim 4 in which the centrifuge has a g-force of 1000 or more.

17. The method of claim 4 in which the centrifuge has a g-force of 3200 or less.

18. A horizontal axis centrifuge containing a separately moving bowl, feeder screw and a) a discharge chamber scraper located outside of the bowl that prevents fouling of the centrifuge discharge chamber by tarry or resinous solids; b) an outlet located in the liquid discharge chamber to extract volatiles from char-solids depleted liquid suspension.

19. The apparatus of claim 18 in which the volatiles include light solids.

20. The apparatus of claim 19 in which the light solids include naphthalene.
